(19) United States
(12) Patent Application Publication
(10) Pub. No.: US 2021/0286997 A1
(43) Pub. Date: Sep. 16, 2021

(54) METHOD AND APPARATUS FOR DETECTING OBJECTS FROM HIGH RESOLUTION IMAGE

(71) Applicant: SK Telecom Co., Ltd., Seoul (KR)

(72) Inventors: Byeong-won LEE, Seoul (KR); Chunfei MA, Seoul (KR); Seungji YANG, Seoul (KR); Joon Hyang CHOI, Seoul (KR); Choong Hwan CHOI, Seoul (KR)

(21) Appl. No.: 17/334,122

(22) Filed: May 28, 2021

Related U.S. Application Data
(63) Continuation of application No. PCT/KR2020/007526, filed on Jun. 10, 2020.

(30) Foreign Application Priority Data
Oct. 4, 2019 (KR) 10-2019-0122897

(51) Int. Cl. G06K 9/00; G06T 7/20; G06T 3/40; G06N 3/08

(52) U.S. Cl. CPC G06K 9/00624; G06T 7/20; G06T 2207/20081; G06N 3/08; G06T 2207/20084; G06T 3/40

(57) ABSTRACT

The present disclosure in some embodiments adaptively generates part images based on a preceding object detection result and object tracking result with respect to a high-resolution image and generates augmented images by applying data augmentation to the part images. The present disclosure provides an object detection apparatus and an object detection method capable of detecting and tracking an object based on artificial intelligence (AI) by using the generated augmented images and capable of performing re-inference based on the detection and tracking result.

### CROSS-REFERENCE TO RELATED APPLICATIONS

The present application is a bypass continuation of International application PCT/KR2020/007526, filed on Jun. 10, 2020, which claims priority to Republic of Korea Patent Application No. 10-2019-0122897, filed on Oct. 4, 2019, which are incorporated by reference herein in their entirety.

### FIELD OF INVENTION

The present disclosure in some embodiments relates to an apparatus and a method for detecting object from high resolution image.

### BACKGROUND OF INVENTION

The statements in this section merely provide background information related to the present disclosure and do not necessarily constitute prior art.

In the field of security, image capture and image analysis using a drone is an important technology at the physical security market as a measure of technological competitiveness. Additionally, in terms of transmission, storage, and analysis of captured images, the image capture and analysis technology is the one that makes frequent use of fifth generation (5G) communication technology. Therefore, such image processing technology is classified as the field where major telecommunications companies are competing for technology development.

Existing analysis technology for a drone-captured image (hereinafter referred to as ‘drone image’ or ‘image’) targets Full-High Definition (FHD, for example, 1K) images captured by a drone flying at about 30 m high. The existing image analysis technology detects objects such as pedestrians, cars, buses, trucks, bicycles, and motorcycles from captured images and utilizes the detection results to provide services such as unmanned reconnaissance, intrusion detection, and criminal exposure.

The 5G communication technology featuring large capacity and low latency characteristics has provided the basis for allowing the use of high-resolution drone images captured with a wider field of view at a higher altitude, including 2K full high definition (FHD) or 4K ultra high definition (UHD) drone images for example. The increase in the photographing altitude and the increase in the resolution of the images render the photographed object to be smaller, which will greatly increase the difficulty of object detection. Therefore, a differentiated technology is required from the conventional analysis technology.

FIG. 3 is an exemplary diagram of a conventional object detection method using a deep learning model based on artificial intelligence (AI). The method includes inputting an image to a pre-learned deep learning model to perform inferencing and detecting an object in the image based on the inferred result. The method shown in FIG. 3 is applicable to an image having a relatively low resolution.

An attempt to apply the method shown in FIG. 3 to a high-resolution image is subject to a performance limitation due to the resolution of the input image. First, the detection performance of a small object may be greatly degraded because the ratio of the size of the object to be detected to the size of the whole image is too small. Second, the internal memory space required for inferencing is destined to increase exponentially in proportion to the image size, consuming a large amount of hardware resources, which will require a large memory and a high-end Graphic Processing Unit (GPU).

FIG. 4 is another exemplary diagram of a conventional object detection method using a deep learning model for a high-resolution image. The scheme shown in FIG. 4 may be used to improve the performance constraints of the technique shown in FIG. 3. The deep learning model used by the method shown in FIG. 4 is assumed to have the same or similar structure and performance as the model used by the method shown in FIG. 3.

This scheme includes dividing a whole image of high resolution into overlapping partitioned images of the same size and utilizing the partitioned images to perform inferencing in a batch method. Mapping the position of an object detected in each partitioned image to the whole image allows to detect the object that is present over the high-resolution whole image. The scheme shown in FIG. 4 exhibits an advantage of saving the occupied memory space, but it still suffers from a fundamental limitation in improving the detection performance with a very small object.

Accordingly, there is a need for a high resolution object detection method with improved performance capable of detecting very small objects from a high-resolution image while efficiently using an existing deep learning model and limited hardware resources.

### SUMMARY OF INVENTION

The present disclosure in some embodiments adaptively generates part images based on a preceding object detection result and object tracking result with respect to a high-resolution image and generates augmented images by applying data augmentation to the part images. The present disclosure seeks to provide an object detection apparatus and an object detection method capable of detecting and tracking an object based on AI by using the generated augmented images and capable of performing re-inference based on the detection and tracking result.

At least one aspect of the present disclosure provides an object detection apparatus including an input unit, a candidate region selection unit, a part image generation unit, a data augmentation unit, an AI inference unit, and a control unit. The input unit is configured to obtain a whole image. The candidate region selection unit is configured to select, based on a first detection result with respect to at least a portion of the whole image, one or more candidate regions of the whole image where an augmented detection is to be performed in the whole image. The part image generation unit is configured to obtain one or more part images corresponding to the candidate regions from the whole image. The data augmentation unit is configured to apply a data augmentation technique to each of the part images and thereby generate augmented images. The AI inference unit is configured to detect an object from the augmented images and thereby generate an augmented detection result. The control unit is configured to locate the object in the whole image based on the augmented detection result and to generate a second detection result.

Another aspect of the present disclosure provides an object detection method performed by a computer apparatus, including obtaining a whole image, and selecting, based on a first detection result with respect to at least a portion of the whole image, one or more candidate regions of the whole image where an augmented detection is to be performed in the whole image, and obtaining one or more part images corresponding respectively to the candidate regions from the whole image, and generating augmented images by applying a data augmentation technique to each of the part images, and generating an augmented detection result by detecting an object for each of the part images by using an AI inference unit that is pre-trained based on the augmented images, and generating a second detection result by locating the object in the whole image based on the augmented detection result.

Yet another aspect of the present disclosure provides a non-transitory computer readable medium storing a computer program including computer-executable instructions for causing, when executed by a computer, the computer to perform an object detection method including obtaining a whole image, and selecting, based on a first detection result with respect to at least a portion of the whole image, one or more candidate regions of the whole image where an augmented detection is to be performed in the whole image, and obtaining one or more part images corresponding respectively to the candidate regions from the whole image, and generating augmented images by applying a data augmentation technique to each of the part images, and generating an augmented detection result by detecting an object for each of the part images by using an AI inference unit that is pre-trained based on the augmented images, and generating a second detection result by locating the object in the whole image based on the augmented detection result.

As described above, some embodiments of the present disclosure provide an object detection apparatus and an object detection method capable of detecting and tracking an object based on AI by using augmented images and capable of performing re-inference based on the detection and tracking result. Utilizing the object detection apparatus and the object detection method achieves an improved detection performance on a complex and ambiguous small object required in a drone service while efficiently using limited hardware resources.

According to some embodiments of the present disclosure, an object detection apparatus and an object detection method are provided with a superior capability over conventional drone-based methods by analyzing a high-resolution image captured with a wider field of view at a higher altitude, mitigating the detecting limitation by drone's flight time based on battery capacity, which allows to offer differentiated security services with drones.

Further, according to the embodiments of the present disclosure, high-resolution images captured by drones can be processed by taking advantage of 5G communication technology that has high-definition, large-capacity, and low-latency characteristics to the benefit of the security field.

### BRIEF DESCRIPTION OF THE DRAWINGS

FIG. 1 is a diagram of a configuration of an object detection apparatus according to at least one embodiment of the present disclosure.

FIGS. 2A and 2B are flowcharts of an object detection method according to at least one embodiment of the present disclosure.

FIG. 3 is an exemplary diagram of a conventional object detection method using an AI-based deep learning model.

FIG. 4 is an exemplary diagram for another conventional object detection method using a deep learning model for a high-resolution image.

FIGS. 5A, 5B, and 5C are exemplary diagrams of inferences and re-inferences according to some embodiments of the present disclosure.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The detailed description to be disclosed hereinafter together with the accompanying drawings is intended to describe exemplary embodiments of the present disclosure, and is not intended to represent the only embodiments in which the present disclosure may be practiced.

The present disclosure illustrates embodiments of a high resolution object detection apparatus and a high resolution object detection method. In more detail, the embodiments perform an object detection with a high-resolution image and include generating adaptive part images thereof and applying data augmentation to the part images to generate augmented images. By utilizing the generated augmented images, the object detection and re-inference can be performed based on AI by the object detection apparatus and object detection method provided by the embodiments of the present disclosure.

In the embodiments, as a result of object detection, a location is identified where an object exists on a given image, and at the same time, the type of the object is also determined. Additionally, a rectangular bounding box including an object is used to indicate the location of the object.

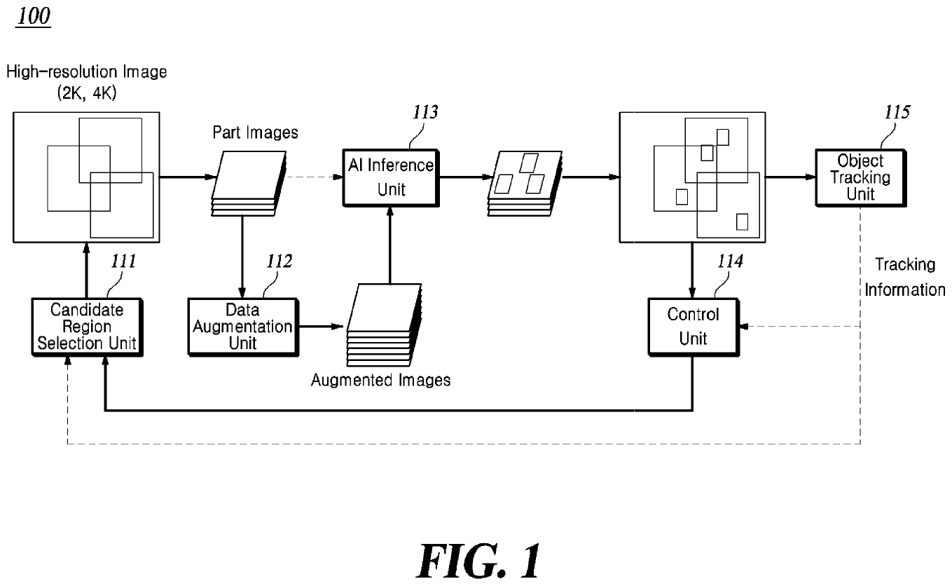

FIG. 1 is a diagram of a configuration of an object detection apparatus 100 according to at least one embodiment of the present disclosure.

In at least one embodiment of the present disclosure, the object detection apparatus 100 generates augmented images from a high-resolution image and utilizes the generated augmented images to detect, based on AI, a small object of a required level for a drone-photographed image. The object detection apparatus 100 includes all or some of a candidate region selection unit 111, a data augmentation unit 112, an AI inference unit 113, a control unit 114, and an object tracking unit 115.

The components included in the object detection apparatus 100 according to some embodiments of the present disclosure are not necessarily limited to these particulars. For example, additionally provided on the object detection apparatus 100 may be an input unit (not shown) for obtaining a high-resolution image and a part image generation unit (not shown) for generating part images.

The illustration of FIG. 1 is an exemplary configuration according to at least one embodiment, which may be variably implemented to include different components or different connections between components according to a candidate region selection method, a data augmentation technique, the structure of an AI inference unit and an object tracking method, etc.

The embodiments of the present disclosure assume that a drone provides high-resolution (e.g., 2K or 4K resolution) image, which is not meant to so limit the present disclosure and may incorporate any device capable of providing a high-resolution image. For real-time analysis or delayed analysis, high-resolution images may be transmitted to a server (not shown) by using a high-speed transmission technology, e.g., 5G communication technology.

The object detection apparatus 100 according to some embodiments is assumed to be installed in a server or a programmable system having computing power equivalent to that of the server.

Additionally, the object detection apparatus 100 according to the embodiments may be installed in a device that generates a high-resolution image, such as a drone. Accordingly, all or some of the operation of the object detection apparatus 100 may be performed by the installed device based on the computing power of the device.

The object detection apparatus 100 according to the embodiments of the present disclosure can improve detection performance by performing three or more inferences per high-resolution image. The first inference is expressed as a preceding inference, the second inference is expressed as a current inference, and the third or later inferences are expressed as re-inference(s). Additionally, the preceding inference generates a preceding inference result as a first detection result, the current inference produces a final inference result as a second detection result, and the re-inference generates a re-inference result.

For convenience of explanation of the embodiments, a high-resolution image may be used interchangeably with a whole image.

Hereinafter, the operation of the respective components of the object detection apparatus 100 will be described with reference to the illustration of FIG. 1.

The object detection apparatus 100 according to some embodiments of the present disclosure has an input unit for obtaining a high-resolution image, that is, a whole image from the drone.

The object detection apparatus 100 according to some embodiments generates a preceding detection result by performing a preceding inference on the whole image. The object detection apparatus 100 first splits the whole image into partitioned images of the same size, in which the images are partially overlapped, as in the conventional technique illustrated in FIG. 4. Thereafter, based on an object inferred using the AI inference unit 113 for each of the partitioned images, the object detection apparatus 100 decisively locates the object in the whole image to finally generate the preceding detection result.

Additionally, the object tracking unit 115 temporally tracks the object with a machine learning-based object tracking algorithm based on the preceding detection result to generate tracking information. Details of the object tracking unit 115 will be described below.

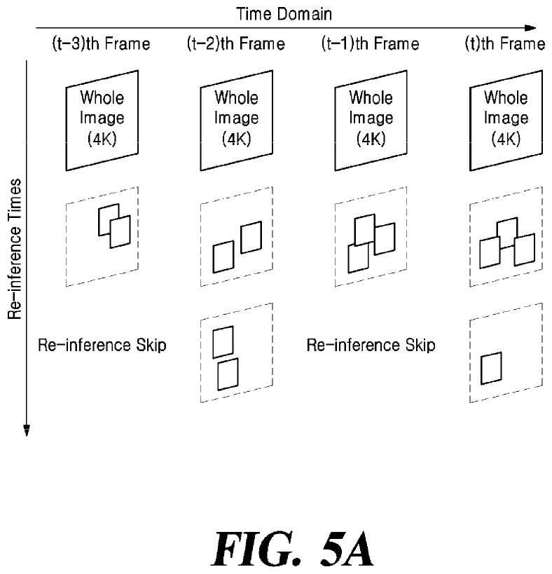

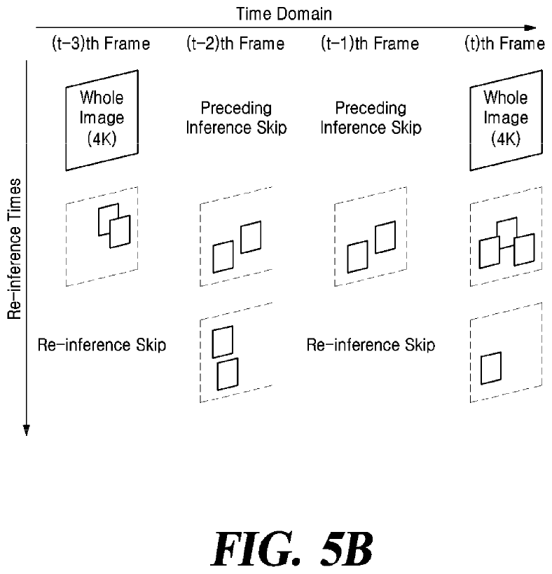

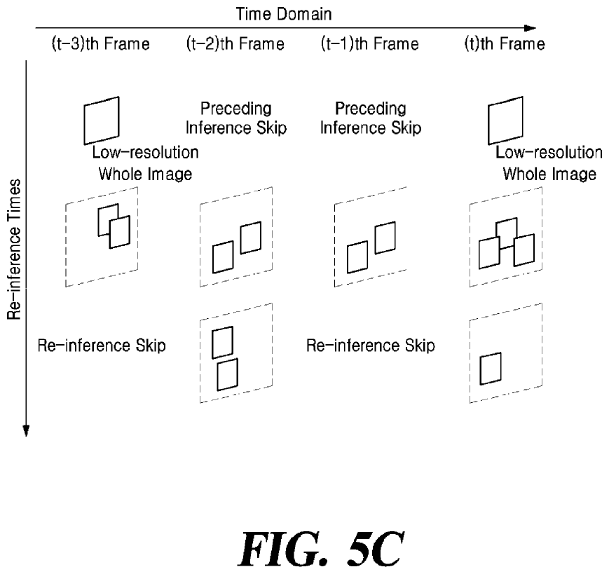

The following describes an example method of saving computing power through FIGS. 5A, 5B, and 5C.

FIGS. 5A-5C are exemplary diagrams of inferences and re-inferences according to some embodiments of the present disclosure.

The illustrations of FIGS. 5A-5C indicate in the horizontal direction a progress of frames in time units and indicate in the vertical direction a preceding inference, a current inference, and repetitive re-inferences as performed.

As shown in FIG. 5A, the object detection apparatus 100 utilizes the high-resolution whole image to perform, every frame unit time, a preceding inference and a current inference, and if the re-inference is needed, then it may utilize the repetitive re-inferences to maximize the object detection performance.

In another embodiment, to reduce the consumed computing power, the present disclosure generates a preceding detection result for each specific period for the whole image inputted.

As shown in FIG. 5B, the object detection apparatus 100 utilizes high-resolution whole images obtained in each frame having a specific period or time interval to perform preceding inferences so as to derive first or preceding detection results. For each of the remaining frames during the specific period, the object detection apparatus 100 utilizes the inference or detection results of the previous frame to perform current inferences and re-inferences on the part images, which can save the computing power required for high resolution image analysis.

In another embodiment of the present disclosure, the object detection apparatus 100 first generates a whole image having a relatively low resolution by using an image processing technique such as down-sampling. Thereafter, the object detection apparatus 100 may use the low-resolution whole image as a basis to split the whole image or skip the splitting process to generate a preceding detection result with the AI inference unit 113. By using the low-resolution whole image, the object detection apparatus 100 can save computing power consumed to generate the preceding detection result.

As shown in FIG. 5C, the object detection apparatus 100 utilizes low-resolution whole images in each frame having a specific period or time interval to perform preceding inferences so as to derive the first or preceding detection results, and in the current inference and re-inference processes on the part images, it may utilize high-resolution images to maximize the efficiency of the computational quantity.

The candidate region selection unit 111 according to some embodiments selects, based on the preceding detection results and tracking information provided by the object tracking unit 115, one or more candidate regions from the whole image as follows.

The candidate region selection unit 111 selects a congestion or mess region based on the preceding detection result for the whole image. The mess region refers to a region where precise detection may be compromised because many objects are concentrated in a small region.

Applying a general object detection technique to a mess region tends to generate a large localization error. That would cause a bounding box for the object to be shaken without the exact location of the object being defined or lead to an overlapped box occurring due to erroneous detection of the object. Therefore, mess regions are selected as candidate regions for elaborate analysis.

The candidate region selection unit 111 detects a low confidence object based on the preceding detection result. To remake the ambiguous judgment by the AI inference unit 113 in the preceding inference, the candidate region selection unit 111 may select the region where the low confidence object was detected as a candidate region and make a second judgement on the low confidence object resulting from the ambiguous judgment by the AI inference unit 113.

The candidate region selection unit 111 determines, based on the preceding detection result, an object smaller than the size predicted based on the surrounding terrain information possessed by the camera mounted on the drone. The candidate region selection unit 111 may select a surrounding region including the small object as a candidate region to make a second judgement over an ambiguous judgment by the AI inference unit 113.

The candidate region selection unit 111 estimates a lost object in the current image based on the preceding detection result and tracking information. The candidate region selection unit 111 may select surrounding regions including the lost object as candidate regions and redetermine the object in consideration of a change in a temporal location of the object.

As described above, since the candidate region selection unit 111 performs a controlling functionality to select various candidate regions, it may also be referred to as a candidate region control unit.

It is assumed that the respective candidate regions selected by the candidate region selection unit 111 have the same size to facilitate the inferencing by the AI inference unit. To equalize the size of the candidate regions, the candidate region selection unit 111 may use a known image processing method such as zero insertion and interpolation.

The candidate region selection unit 111 according to some embodiments select, based on the current inference result, at least one candidate region from the whole image to perform re-inference.

The candidate region selection unit 111 includes each of the objects detected in the preceding inferences or the current inferences into at least one of the selected candidate regions. Additionally, a region obtained by combining all of the candidate regions selected by the candidate region selection unit 111 may not be the entirety of the whole image. Accordingly, the object detection apparatus 100 according to the present disclosure can reduce computing power required for high-resolution image analysis by using only the selected candidate regions, not the whole image, as the object detection target region.

When the candidate region selection unit 111 can select not a single candidate region based on the preceding detection result and tracking information, e.g., when there is no object of interest in the whole image, the object detection apparatus 100 may omit the current inference and terminate the inferencing.

The present disclosure in some embodiments has a part image generation unit for obtaining, from the whole image, one or more part images corresponding to the respective candidate regions.

The data augmentation unit 112 according to some embodiments generates an augmented image by applying an adaptive data augmentation technique to the respective part images.

The data augmentation unit 112 uses various techniques including, but not necessarily limited to, up-sampling, rotation, flip, and color space modification as a data augmentation technique. Here, the upsampling is a technique that enlarges the image, and the rotation is to rotate the image. Additionally, the flip is a technique of obtaining a mirror image that is symmetrical vertically or horizontally, and the color space modulation is a technique of obtaining a part image to which a color filter is applied.

The data augmentation unit 112 may maximize detection performance by supplementing the cause of deterioration in its detection performance by applying an adaptive data augmentation technique for each of the candidate regions.

With respect to the part image for the mess region, the data augmentation unit 112 may generate an increased number of augmented images by applying augmentation techniques such as upsampling, rotation, flip, and color space modulation. With the augmentation techniques applied, a plurality of cross-checks can be provided to improve the overall performance of the object detection apparatus 100.

Against a part image including a low confidence object, the data augmentation unit 112 may supplement the reliability of the low confidence object by restrictively applying one to two designated augmentation techniques.

For a part image including a small object, the data augmentation unit 112 may improve detection performance for the small object by processing data based on up-sampling.

With respect to the part image including a lost object, the data augmentation unit 112 may improve detection performance in the current image by restrictively applying one to two designated augmentation techniques.

The data augmentation unit 112 generates the same or increased number of augmented images for the respective part images by applying the data augmentation techniques as described above.

To facilitate the inferencing of the AI inference unit, it is assumed that the sizes of the augmented images generated by the data augmenting unit 111 are all the same. To equalize the size of the augmented images, the data augmentation unit 111 may use a known image processing method such as zero insertion and interpolation.

It is assumed that a unitary size is shared between the candidate regions selected by the candidate region selection unit 111, the part images generated by the part image generation unit, and the augmented images generated by the data augmentation unit 112.

When performing the re-inference, to maximize object detection performance, the data augmentation unit 112 may apply a data augmentation technique different from the technique applied to the preceding inference on the same part image. In the performing of re-inference, repeating the same preceding inference on the same augmented image would only give a similar result. Therefore, a superior object detection performance can be secured over the preceding inference by augmenting and amplifying the part images in a different manner and comprehensively judging the results.

As a data augmentation technique for re-inferencing, the data augmentation unit 112 uses various image processing techniques including, not necessarily limited to, upsampling, rotation, flip, color space modulation, and high dynamic range converting (HDR). The present disclosure bases the results of re-inferencing on data amplified by using these various augmentation techniques, resulting in a multiple-decision effect and contributing to the performance improvement of re-inferencing results.

In the process of re-inferencing, the data augmentation unit 112 may use the right judgement when determining which data augmentation technique is effective according to the target object and the current image state. When expecting detection of a relatively small object such as a pedestrian/bicycle, the data augmentation unit 112 may generate an up-sampled augmented image, and when determining that the color of the object and the background color are similar, it may generate an augmented image to which color space modulation is applied. Additionally, upon determining that no object has been detected having a sufficiently large and standardized shape such as a vehicle, the data augmentation unit 112 may generate an augmented image to which a technique such as rotation/flip is applied, and when in a too dark or bright situation due to changes in weather/lighting, it may generate an augmented image to which the HDR technique is applied. To improve image quality and object detection performance in the process of re-inferencing, the data augmentation unit 112 may use various existing image processing techniques including the techniques described above.

The AI inference unit 113 performs current inference by detecting an object for each augmented image based on batch execution on the augmented image and generates an augmented detection result. The operation of the AI inference unit 113 for detecting an object by using the augmented images provides an effect of cross-detecting one object in various ways.

The AI inference unit 113 is implemented as a deep learning-based model which may be anyone available for object detection, such as You Only Look Once (YOLO) or Region-based Convolutional Neural Network (R-CNN) series of models (e.g., Faster R-CNN, Mask R-CNN, etc.), Single Shot Multibox Detector (SSD), etc. The deep learning model may be trained in advance by using training images.

Regardless of doing preceding inference, current inference, or re-inference, the AI inference unit 113 is assumed to have the same structure and function.

The control unit 114 determines, based on the augmented detection result, the position of the object in the whole image to generate a final detection result. The control unit 114 may generate a final detection result by using the detection frequency and reliability of the object cross-detected by the AI inference unit 113.

The control unit 114 may use the object tracking unit 115 based on the final detection result to generate tracking information for the object and determine whether to further perform re-inferences based on the final detection result, the preceding detection result, and the tracking information.

The control unit 114 calculates, based on the final detection result, the preceding detection result, and the tracking information provided by the object tracking unit 115, an amount of change in a determination measure used to select the candidate regions. The control unit 114 may determine whether to perform re-inference by analyzing the amount of change in the determination measure.

As described above, since the control unit 114 determines whether to perform re-inference by using obtained and/or generated information, it may be referred to as a re-inference control unit.

Further to the analysis on the amount of change in the determination measure, the following describes various embodiments in which decision is made on whether or not to perform re-inference.

When the object that was detected in the previous (t-a)-th frame is not detected in the current t-th frame, it is determined that the object has been missed, and a region in which the object previously existed may be set as a candidate re-inference region.

When the object detection results show to overlap each other making it difficult to determine the exact object location, the relevant region may be set as a candidate re-inference region.

In general, objects often appear/disappear at the boundary of an image, and the frequency of appearances/disappearances is low inside of the image. Therefore, when an object that did not exist is suddenly detected in the current inference inside the image, a re-inference process may be used to determine whether the relevant object is a newly appeared object out of a building, tree or other structures or it has been erroneously detected.

When detecting an object of high importance e.g., in a security intrusion detection where detection of a person is the most important, a suspicious situation needs to be determined even with a low detection confidence in the preceding inference. Therefore, to minimize the case of missing detection of a person, the relevant region may be set as a candidate re-inference region.

When a whole image has a specific part that renders its detection to be increasingly difficult according to external environmental factors, such as when the specific part is shadowed by a building and becomes darker than other parts of the image, that part may be set to be a candidate re-inference region.

The object tracking unit 115 generates tracking information by temporally tracking the object based on the final detection result by using a machine learning-based object tracking algorithm. Here, the machine learning-based algorithm to be used may be any one of open-source algorithms such as Channel and Spatial Reliability Tracker (CSRT), Minimum Output Sum of Squared Error (MOSSE), and Generic Object Tracking Using Regression Networks (GOTURN).

The tracking information generated by the object tracking unit 115 may be information on the object location generated by predicting an object location in the current image from the object location in the previous image in time. Additionally, the tracking information may include information on the candidate region generated by predicting a candidate region in the current image from the candidate region of the previous image.

The object tracking unit 115 may perform object tracking in all processes such as preceding inference, current inference, and re-inference. The object tracking unit 115 provides its generated tracking information to the control unit 114 and the candidate region selection unit 111.

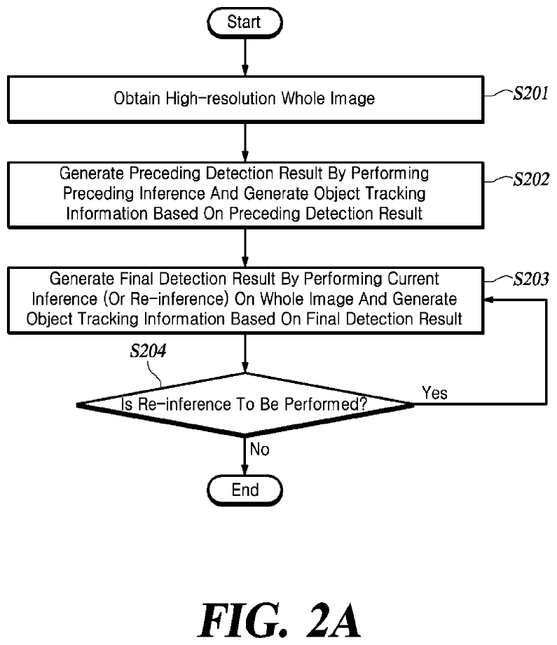

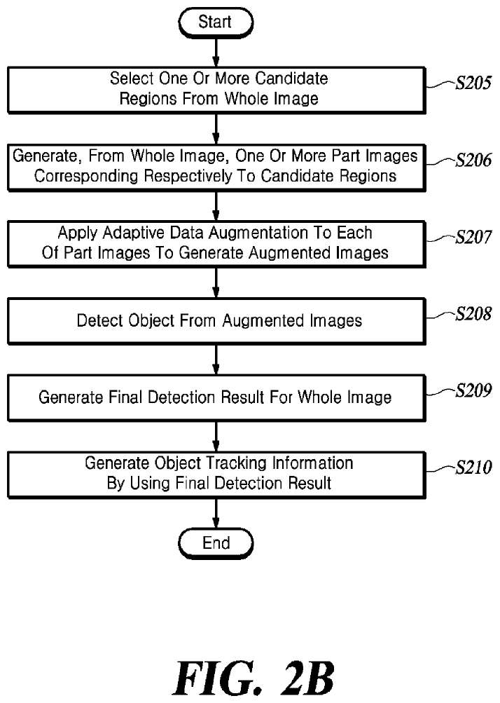

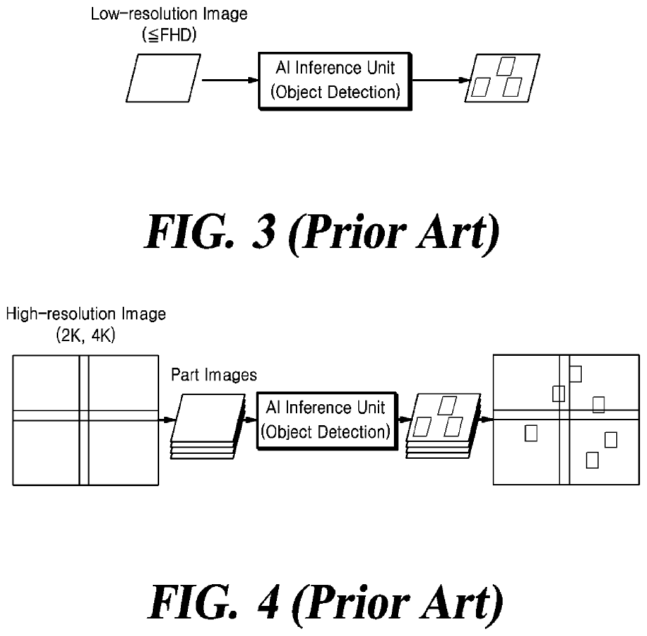

FIGS. 2A and 2B are flowcharts of an object detection method according to at least one embodiment of the present disclosure. Flowchart of FIG. 2A shows an object tracking method in terms of execution of preceding inference, current inference, and re-inference. Flowchart of FIG. 2B shows the current inference (or re-inference) step.

The following describes flowchart in FIG. 2A.

The object detection apparatus 100 according to some embodiments of the present disclosure obtains a high-resolution whole image (in Step S201).

The object detection apparatus 100 generates a preceding detection result by performing a preceding inference and generates object tracking information based on the preceding detection result (S202). The process of generating the preceding detection result and object tracking information is the same as described above.

The object detection apparatus 100 generates a final detection result by performing a current inferencing process on the whole image and generates object tracking information based on the final detection result (S203). The object detection apparatus 100 may generate a re-inferencing result by performing a re-inference process on the whole image and generate the object tracking information based on the re-inferencing result.

The current inferencing (or re-inferencing) process will be described below with flowchart of FIG. 2B.

The object detection apparatus 100 determines whether or not to perform re-inference (S204). The object detection apparatus 100 further performs the re-inference based on the preceding detection result, the final detection result, and the determination result based on the object tracking information (S203), or it terminates the inferencing.

The following describes the current inferencing (or re-inferencing) step in the illustrated sequence as flowchart in FIG. 2B.

The object detection apparatus 100 according to some embodiments of the present disclosure selects one or more candidate regions from the whole image (S205).

The candidate regions include, but are not limited to, a mess region, a region inclusive of a low confidence object, a region inclusive of a small object, a region inclusive of a lost object, and the like.

The object detection apparatus 100 may select, from the whole image, one or more candidate regions for the current inference based on the preceding inference result, in particular, the preceding detection result and the object tracking information generated by using the preceding detection result.

The object detection apparatus 100 may select, from the whole image, one or more candidate regions for re-inference based on the current inference result, in particular, the final detection result and the object tracking information generated by using the final detection result.

The respective objects detected through the preceding inference or the current inference are included in at least one of the candidate regions. The region made of the selected candidate regions composed may not be the entirety of the whole image. Therefore, at the time of current inference or re-inference, the object detection apparatus 100 according to some embodiments may use the selected candidate regions exclusively as the target regions for object detection, not the whole image, thereby reducing the computing power required for high-resolution image analysis.

When no candidate region can be selected based on the preceding detection result and tracking information, e.g., when there is no object of interest in the whole image, the object detection apparatus 100 may omit the current inference and terminate the inferencing.

The object detection apparatus 100 generates, from the whole image, one or more part images corresponding respectively to the candidate regions (S206).

The object detection apparatus 100 applies adaptive data augmentation to each of the part images to generate augmented images (S207). Various data augmentation techniques are used including, but not limited to, upsampling, rotation, flip, and color space modulation.

The object detection apparatus 100 generates the same or increased number of augmented images for the respective part images by applying various data augmentation techniques.

The object detection apparatus 100 may maximize detection performance by compensating for a cause of deterioration in detection performance by applying an adaptive data augmentation technique that is right for each selected candidate region.

When performing the re-inference, a data augmentation technique different from the data augmentation technique that was applied to the preceding inference may be applied to the same part image.

The object detection apparatus 100 detects an object from the augmented images (S208).

The object detection apparatus 100 performs current inference (or re-inference) by using the AI inference unit 113. The AI inference unit 113 detects objects each for each of the augmented images. To facilitate inferencing by the AI inference unit 113, it is assumed that the respective candidate regions and the augmented images derived from the candidate regions all share a unitary size. Utilizing the augmented images for object detection provides the effect of cross-detecting a single object in various ways.

The object detection apparatus 100 generates a final detection result for the whole image (S209).

The object detection apparatus 100 generates the final detection result by decisively locating the object in the whole image based on the frequency and reliability of detections of the cross-detected object.

The object detection apparatus 100 generates object tracking information by using the final detection result (S210).

The object detection apparatus 100 generates the tracking information by temporally tracking the object by using a machine learning-based object tracking algorithm based on the detection result of the current inference (or re-inference).

The tracking information generated may be information on the object location generated by predicting an object location in the current image from the object location in the previous image in time. Additionally, the tracking information may include information on the candidate region generated by predicting a candidate region in the current image from the candidate region of the previous image.

As described above, some embodiments of the present disclosure provide an object detection apparatus and an object detection method capable of detecting and tracking an object based on AI by using augmented images and capable of performing re-inference based on the detection and tracking result. Utilizing the object detection apparatus and the object detection method achieves an improved detection performance on a complex and ambiguous small object required in a drone service while efficiently using limited hardware resources.

According to some embodiments of the present disclosure, an object detection apparatus and an object detection method are provided with a superior capability over conventional drone-based methods by analyzing a high-resolution image captured with a wider field of view at a higher altitude, mitigating the detecting limitation by drone's flight time based on battery capacity, which allows to offer differentiated security services with drones.

Further, according to the embodiments of the present disclosure, high-resolution images captured by drones can be processed by taking advantage of 5G communication technology that has high-definition, large-capacity, and low-latency characteristics to the benefit of the security field.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. Computer programs (which are also known as programs, software, software applications, or code) contain instructions for a programmable processor and are stored in a “computer-readable recording medium.”

The computer-readable recording medium represent entities used for providing programmable processors with instructions and/or data, such as any computer program products, apparatuses, and/or devices, for example, a non-volatile or non-transitory recording medium such as a CD-ROM, ROM, memory card, hard disk, magneto-optical disk, storage device.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, a network device, a set-top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. An object detection apparatus, comprising:
an input unit configured to obtain a whole image;
a candidate region selection unit configured to select, based on a first detection result with respect to at least a portion of the whole image, one or more candidate regions of the whole image where an augmented detection is to be performed in the whole image;
a part image generation unit configured to obtain one or more part images corresponding to the candidate regions from the whole image;
a data augmentation unit configured to apply a data augmentation technique to each of the part images to generate augmented images;
an artificial intelligence (AI) inference unit configured to detect an object from the augmented images and thereby generate an augmented detection result; and
a control unit configured to locate the object in the whole image based on the augmented detection result and to generate a second detection result.

2. The object detection apparatus of claim 1, wherein the control unit is configured to determine whether or not to allow the AI inference unit to further perform re-inference on the candidate regions, based on the first detection result and the second detection result.

3. The object detection apparatus of claim 1, wherein the AI inference unit is configured to generate the first detection result in advance by inferring the object from the whole image.

4. The object detection apparatus of claim 1, wherein the candidate region selection unit is configured to select the candidate regions, based on the first detection result with respect to at least the portion of the whole image, from any one of:
a mess region in which a plurality of objects are concentrated in a narrow area;
a region where a low confidence object is detected; and
a region that presents an object smaller than a size predicted based on a surrounding terrain information.

5. The object detection apparatus of claim 1, wherein the candidate region selection unit is configured to include each of detected objects according to the first detection result in at least one of the candidate regions.

6. The object detection apparatus of claim 1, wherein the data augmentation unit is configured to generate one or more augmented images for each of the part images by applying one or more data augmentation techniques to each of the candidate regions.

7. The object detection apparatus of claim 2, wherein, when the re-inference on the whole image is determined to be performed by the control unit, the data augmentation unit applies, to the respective part images, a data augmentation technique different from the data augmentation technique previously applied for inference.

8. The object detection apparatus of claim 2, further comprising:
an object tracking unit configured to temporally track the object by using a machine learning-based object tracking algorithm based on the first detection result and the second detection result to generate tracking information,
wherein the tracking information comprises:
information indicative of a predicted object position in a current image, which is predicted from an object position in a previous image, or
information indicative of one or more predicted candidate regions of the current image, which are predicted from candidate regions of the previous image.

9. The object detection apparatus of claim 8, wherein the tracking information is further used for the control unit to determine whether to perform the re-inference or for the candidate region selection unit to select the candidate regions of the whole image.

10. The object detection apparatus of claim 9, wherein the candidate region selection unit additionally selects a region containing a lost object, when occurred, as one of the candidate regions by using the first detection result and the tracking information.

11. The object detection apparatus of claim 2, wherein the whole image is obtained in each frame having a specific period and the remaining frames during the period are used for the re-inference.

12. The object detection apparatus of claim 11, wherein the whole image obtained in each frame having the specific period is down-sampled into a lower resolution and then is used to generate the first detection result.

13. An object detection method performed by a computer apparatus, comprising:
obtaining a whole image;
selecting, based on a first detection result with respect to at least a portion of the whole image, one or more candidate regions of the whole image where an augmented detection is to be performed in the whole image;
obtaining one or more part images corresponding respectively to the candidate regions from the whole image;
generating augmented images by applying a data augmentation technique to each of the part images;
generating an augmented detection result by detecting an object for each of the part images by using an artificial intelligence (AI) inference unit that is pre-trained based on the augmented images; and
generating a second detection result by locating the object in the whole image based on the augmented detection result.

14. The object detection method of claim 13, further comprising:
determining whether or not to allow the AI inference unit to further perform re-inference on the candidate regions based on the first detection result and the second detection result.

15. The object detection method of claim 13, wherein the AI inference unit is configured to generate the first detection result in advance by inferring the object from the whole image.

16. The object detection method of claim 14, further comprising:
generating tracking information by temporally tracking the object by using a machine learning-based object tracking algorithm based on the second detection result,
wherein the tracking information is configured to be used by the selecting of the candidate regions and the determining of whether or not to perform the re-inference.

17. A non-transitory computer readable medium storing a computer program including computer-executable instructions for causing, when executed by a computer, the computer to perform an object detection method comprising:
obtaining a whole image;
selecting, based on a first detection result with respect to at least a portion of the whole image, one or more candidate regions of the whole image where an augmented detection is to be performed in the whole image;
obtaining one or more part images corresponding respectively to the candidate regions from the whole image;
generating augmented images by applying a data augmentation technique to each of the part images;
generating an augmented detection result by detecting an object for each of the part images by using an artificial intelligence (AI) inference unit that is pre-trained based on the augmented images; and
generating a second detection result by locating the object in the whole image based on the augmented detection result.

18. The non-transitory computer readable medium of claim 17, wherein the computer-executable instructions cause, when executed by the computer, the computer to further perform:
determining whether or not to allow the AI inference unit to further perform re-inference on the candidate regions based on the first detection result and the second detection result.

19. The non-transitory computer readable medium of claim 17, wherein the computer-executable instructions cause, when executed by the computer, the computer to allow the AI inference unit to generate the first detection result in advance by inferring the object from the whole image.

20. The non-transitory computer readable medium of claim 18, wherein the computer-executable instructions cause, when executed by the computer, the computer to further perform:
generating tracking information by temporally tracking the object by using a machine learning-based object tracking algorithm based on the second detection result,
wherein the tracking information is configured to be used by the selecting of the candidate regions and the determining of whether or not to perform the re-inference.
